(19) United States
(12) Patent Application Publication
(10) Pub. No.: US 2004/0018276 A1
(43) Pub. Date: Jan. 29, 2004

(54) Snack

(75) Inventor: Yen Chin Hsieh, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/454,727

(22) Filed: Jun. 4, 2003

Related U.S. Application Data
(60) Provisional application No. 60/386,016, filed on Jun. 5, 2002.

(51) Int. Cl. A23G 3/00

(52) U.S. Cl. 426/94

(57) ABSTRACT

The snack has one or more features that are designed to facilitate eating snack chips in more than one bite without spilling any dip placed thereon. Also, one or more features on the snack provide at least one signal to an eater for bite placement, bite size and consistent, predictable snack chip breakage in the mouth and/or hand. Favorably, one or more features in the snack enables the snack to contain dip without getting dip on fingers with each bite.

### CROSS REFERENCE TO RELATED APPLICATIONS

This application claims priority to U.S. Provisional Application No. 60/386,016, filed Jun. 5, 2002.

### FIELD OF THE INVENTION

The snack has one or more features that are designed to facilitate eating snacks, e.g., snack chips, in more than one bite without spilling any dip placed thereon. Also, one or more features on the snack provide at least one signal to an eater for bite placement, bite size and predictable, consistent snack chip breakage in the mouth and/or hand. Favorably, one or more features in the snack enables the snack to contain dip without getting dip on the fingers with each bite.

### BACKGROUND OF THE INVENTION

Known products on the market can be eaten in more than one bite; however, the eater is never sure the snack will break in a predictable way and therefore is often caught off-guard by spills and mess in social and everyday eating occasions. The shape of the snack herein is better for social eating situations where spills during eating can lead to mess and embarrassment to the eater, especially where spills equate to extra work in clean up. A function of the design of the snack is to aid in bite placement so that the snack breaks consistently and substantially in one place on the snack (i.e., about the continuous surface area) so that crumbs and snack loss are minimized.

Incorporating multiple to-be-dipped (i.e., concave) sections into a single snack can also allow for packaging of a given number of dippable snack sections in less volume than if these same amounts of dippable or concave sections were provided at a ratio of one per snack. Also, it significantly reduces the amount of times that the eater has to reach into a container to grab a snack for dipping, since, after dipping and consuming one section, one or more distinguishable dippable sections will still be available in the hand for ready consumption. This also has the benefit of limiting the collision frequency of multiple eaters reaching simultaneously for the same container holding the snacks, and increasing the enjoyment of the snacking experience.

Multiple concave sections also have processing advantages particularly when individual molds are used to set the shape during frying, baking or other types of cooking. The main advantage relates to the increased density of distinguishable dippable/concave sections per unit length of frying, baking or other cooking step that can be achieved by having more than one concave section within the same mold. This can help reduce the speed of the production line for a given number of dippable sections and for a given fryer or oven length. Said another way, it can help to maximize production of snacks per unit time for a given production line speed and for a given fryer or oven length.

### SUMMARY OF THE INVENTION

Accordingly, the invention provides a snack having a surface area, comprising a first side, a second side opposed to the first side, a first region that is concave, a second region that is concave opposed to the first region, and a continuous surface area positioned between the first region and the second region (wherein the continuous surface area provides a zone of demarcation between the first region and the second region).

In practice, the continuous surface area provides a signal of placed separation of the first region from the second region. Also, the continuous surface area provides a signal of predictable, consistent breakage (i.e., separation) of the first region from the second region wherein the remaining first region or second region remains substantially intact. Additionally, the continuous surface area provides a signal of bite placement and bite size. Alternatively, the first region and second region provide signals of minimal dip spillage. This is achieved in combination with the continuous surface area that acts as a zone of demarcation between the first region and the second region. Proper signaling to an eater is effected by one or more visual signals an eater gains in observation of the snack and/or by the feel of the snack in an eater's mouth during consumption of the snack; i.e., the snack created to communicate both visually and by feel of the snack within an eater's mouth—by texture and by structure of the snack. In particular, as it regards the structure, a region preferably, either the first or second region, when loaded into an eater's mouth substantially lays within the contours of an eater's tongue and lower jaw by contouring the proportions of an eater's mouth.

In practice, the continuous surface area provides substantially predictable, consistent breakage between the first and the second regions via an application of force upon or close to the continuous surface area. In other words, as force is applied from one or more angles to or close to the continuous surface area, the snack will consistently break in a predictable way about the continuous surface area such that the first region or the second region (i.e., whichever region is held by an eater and consumed last) remains substantially intact for further dipping and/or eating in whole.

Preferably, the continuous surface area is substantially planar. Also preferably, the continuous surface area provides a bending moment about which the first region and the second region arch upwardly away from a plane. Also preferably, the continuous surface area is symmetric.

The first region possesses a concavity that encompasses a volume. Preferably the first region fully encompasses a volume. Also, the second region possesses a concavity that encompasses a volume. Also preferably the concavity of the second region fully encompasses a volume. The first region can substantially be a mirror image of the second region. Of course, the converse is also true.

The snack may comprise corn. The snack may also comprise potato. The snack may comprise wheat. The snack may comprise two or more of a combination of corn, potato or wheat. The continuous surface area of the snack may comprise at least one printed image for aesthetic appeal and/or as a further signaling device. Likewise, the continuous surface may comprise an embedded indication.

### BRIEF DESCRIPTION OF THE DRAWINGS

While the specification concludes with claims particularly pointing out and distinctly claiming the subject matter which is regarded as forming the present invention, it is believed that the invention will be better understood from the following descriptions which are taken in conjunction with the accompanying drawings in which like designations are used to designate substantially identical elements, and in which:

FIG. 1 is a perspective view of the snack held by an eater at one end and partially loaded with dip at the other end;

FIG. 2 is a perspective view of the snack;

FIG. 3 is a side view of the snack of FIG. 2;

FIG. 4 is a top view of the snack of FIG. 2; and

FIG. 5 is an alternative view of the snack of FIG. 2.

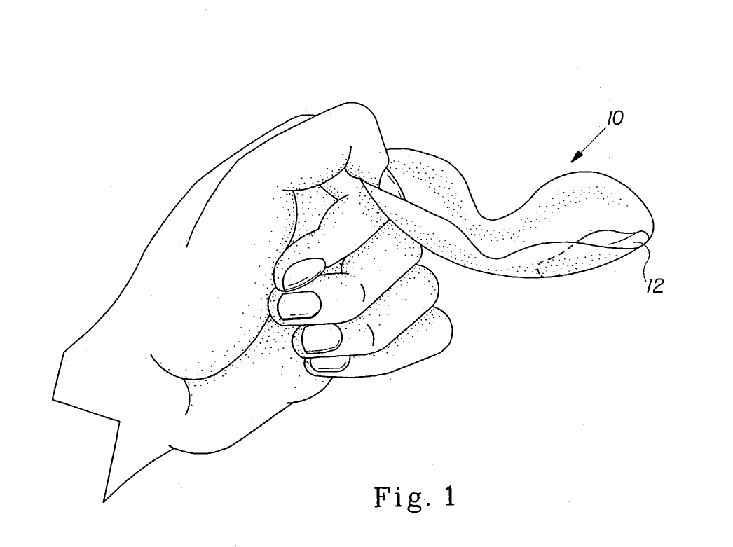

### DETAILED DESCRIPTION OF THE DISCLOSURE

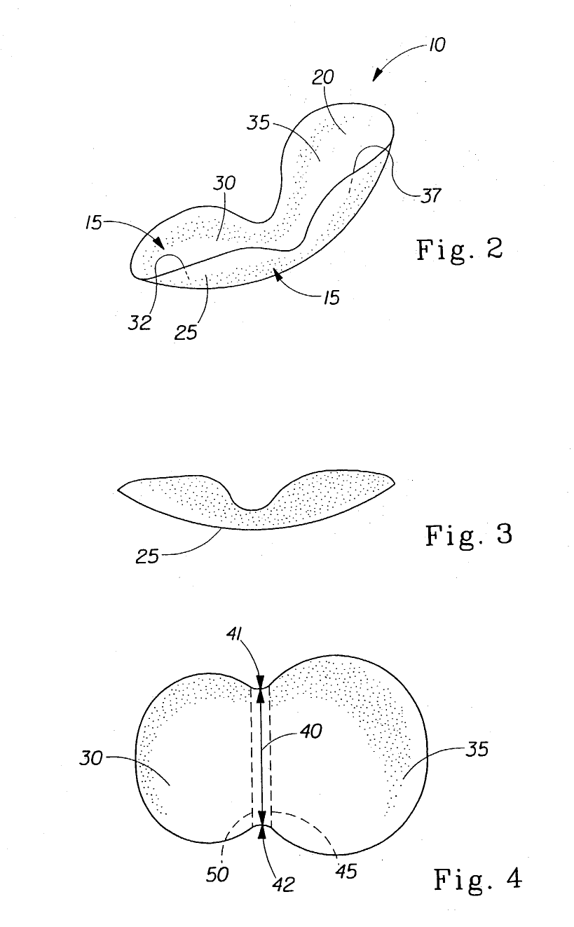

As is shown in FIG. 2, the invention provides a snack 10 having a surface area 15, comprising a first side 20, a second side 25 opposed to the first side 20, a first region 30 that is concave, a second region 35 that is concave opposed to the first region 30, and a continuous surface area 40 positioned between the first region 30 and the second region 35.

In practice, the continuous surface area 40 provides a signal of placed separation of the first region 30 from the second region 35. By the term “placed separation” it is meant herein the separation of the first region 30 from the second region 35 along and/or about the continuous surface area 40. Also, the continuous surface area 40 provides a signal of predictable, consistent breakage of the first region 30 from the second region 35. Additionally, the continuous surface area 40 provides a signal of bite placement and bite size. Also, the first region 30 and second region 35 provide signals of minimal dip spillage. This is achieved in combination with the continuous surface area 40 that acts as a zone of demarcation between the first region 30 and the second region 35. By the term “zone of demarcation” it is meant herein a point or area that operates as a borderline between the first region 30 and the second region 35.

In practice, the continuous surface area 40 provides substantially consistent breakage between the first and the second regions 30, 35 via an application of force upon the continuous surface area. In other words, as force is applied from one or more angles to or close to the continuous surface area 40, the snack preferably will consistently break in a predictable way about the continuous surface area 40 such that the first region 30 or the second region 35 (i.e., whichever region is held by an eater and consumed last) remain substantially intact for further dipping and/or eating in whole. Preferably, the continuous surface area 40 is the area through which substantially most of the breakage of the snack 10 occurs when force is applied to the continuous surface 40. This predictable, consistent breakage occurs whether the snack 10 is broken in an eater's mouth or within an eater's hands.

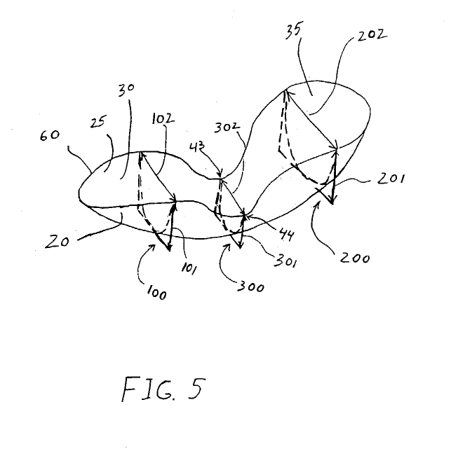

Preferably, the above-mentioned signal to the eater is provided by a continuous surface area 40 that is characterized by criteria set forth herein. This criteria relates to dimensions of characteristic rectangles of the continuous surface area 40, and first and second regions 30, 35. To help the reader understand the criteria, specific elements will be first described and will be better understood in light of FIG. 5.

We define the periphery 60 of the snack as the collection of points that divide the first side 20 from the second side 25, or, otherwise, the collection of outermost points of the edge of the snack 10. We define a continuous surface area 40 as a continuous area of the surface of the snack 10 that fully separates first and second regions 30, 35, and that can be contained in its entirety within a circular cylinder with a diameter of 10 millimeters. This continuous surface area 40 has ends 41 and 42 that locate the collection of points of the periphery 60 that form the end of the continuous surface area 40. End 41 includes a specific end point 43 that is the point closest to the geometrical center, or otherwise center of gravity, of the continuous surface area 40. Analogously, end 42 includes a specific end point 44 that is the point closest to the geometrical center, or otherwise center of gravity, of the continuous surface area 40.

We define a center rectangle 300, as the rectangle of smallest area that fully encloses a cross-section of the continuous surface area 40 within the plane of the rectangle, such cross-section including the specific end points 43 and 44. This center rectangle 300 is composed by two dimensions herein referred to as Width 301 and Length 302, and shown in perspective in FIG. 5. These two dimensions may also be referred to as the characteristic width and characteristic length of the continuous surface area. We define a first rectangle 100 as the rectangle of largest area, taken from the collection of rectangles each of the smallest areas that are parallel to the center rectangle 300 that fully enclose cross-sections of the first region 30. For example, to determine the first rectangle 100, we first determine all the possible cross-sections of the first region 30, such that these cross-sections are parallel to the center rectangle 300. Second, we determine for each cross-section the rectangle of smallest area that fully encloses the cross-section within the plane of the rectangle. Third and last, we determine which of these rectangles is the one of largest area. This first rectangle 100 comprises two dimensions herein referred to as Width 101 and Length 102, and shown in perspective in FIG. 5. These two dimensions may also be referred to as the characteristic width and characteristic length of the first region 30.

Similarly, we define a second rectangle 200 as the rectangle of largest area, taken from the collection of rectangles each of smallest area that are parallel to the center rectangle 300 that fully enclose cross-sections of the second region 35. This second rectangle 200 comprises two dimensions herein referred to as Width 201 and Length 202, and shown in perspective in FIG. 5. These two dimensions may also refer to the characteristic width and characteristic length of the second region 35. Note that in all cases, the width of a given rectangle is smaller than the length of that rectangle.

Given the above definitions, the above mentioned signal to the eater is provided by a continuous surface area 40 that is preferably characterized by a Width 301 that is smaller than Width 101 and smaller than Width 201, and also characterized by a Length 302 that is smaller than Length 102 and smaller than Length 202. Preferably, the Width 301 is smaller than Width 101 and Width 201 by at least about 1 millimeter, and also preferably the Length 302 is smaller than Length 102 and Length 202 by at least about 1 millimeter.

At least a portion of the continuous surface area 40 is substantially planar and has two ends 41 and 42 as is shown in FIG. 4. By the term “substantially planar” it is meant herein that at least 30% of the continuous surface area 40 is substantially flat. Preferably, the continuous surface area 40 provides a bending moment 45 about which the first region 30 and the second region 35 arch upwardly away from a plane. Also preferably, the continuous surface area 40 is symmetric. By the term “symmetric” it is meant herein that one end 41 of the continuous surface 40 has substantially the same geometric measurements and configuration as the other end 42 relative to the rest of the snack 10 as is shown in FIG. 4.

The first region 30 possesses a concavity that encompasses a volume. Preferably the first region 30 fully encompasses a volume. By the term “fully encompasses a volume” it is meant herein a concavity substantially possessing a bowl-like configuration that can retain a substance (e.g., liquid, dip, etc.) placed therein. Also, the second region 35 possesses a concavity that encompasses a volume. Also preferably the concavity of the second region 35 fully encompasses a volume. The first region 30 can preferably be at least a near mirror image of the second region 35. Of course, the converse is also true.

The snack 10 may comprise corn. The snack 10 may also comprise potato. The snack 10 may comprise wheat. The snack 10 may comprise two or more of a combination of corn, potato or wheat. The continuous surface area 40 of the snack may comprise at least one printed image for aesthetic appeal and/or as a further signaling device. Likewise, the continuous surface area 40 may comprise an embedded indication. The snack of the present invention may comprise one or more of potato flour, potato granules, corn flour, masa corn flour, corn grits, corn meal, rice flour, wheat flour, buckwheat flour, oat flour, bean flour, barley flour, tapioca, as well as modified starches, native starches, and pea starches, starch derived from tubers, legumes and grains, for example cornstarch, wheat starch, rice starch, waxy corn starch, oat starch, cassava starch, waxy barley, waxy rice starch, glutinous rice starch, sweet rice starch, amioca, potato starch, tapioca starch, or mixtures thereof.

In practice, the snack 10 has at least one feature that is designed to facilitate eating the snack 10 in more than one bite without spilling any dip that is placed thereon. In one embodiment herein, one or more signals on the snack 10 indicate to an eater an appropriate bite placement, bite size and predictable, consistent breakage. Preferably, the snack 10 is also able to contain dip within the snack's concave portions 32, 37 without getting dip on an eater's fingers.

The snack's design signals to eaters the intended function of the snack 10. Namely, the snack 10 communicates the point or area of breakage for the snack 10, whether breakage comes in an eater's hands or mouth, the dipability of the snack 10, such that dip can be fully encompassed within one or more of the regions 30, 35 of the snack 10, bite placement on the snack 10, the size of the bite to take on the snack 10, and predictable consistent breakage of the snack 10 about the continuous surface area 40.

Communication of predictable, consistent breakage is important because the configuration of the snack 10 is meant to instill confidence in an eater's consumption of the snack 10 especially when that snack 10 contains a dip. This communication further elucidates important function of snack 10: i.e., to hold a dip within the concave regions 30 and 35 of the snack without spilling the dip.

Preferably, the snack 10 should have at least two regions 30, 35, but could have more than two (e.g., three or more). In one embodiment herein, the different regions of snack 10 could also possess varied multiply shaped regions in one snack 10 (e.g., circles, squares, octagonals, etc.).

To produce predictable, consistent breakage, snack 10 could be scored to offer a zone of weakness 50 within the continuous surface area 40 (FIG. 4). A balance must be accomplished between providing sufficient strength in the snack 10 overall to avoid premature breakage, while providing sufficient weakness along the continuous surface area 40 to produce predictable, consistent breakage.

In a preferred embodiment herein, the ends 41 and 42 are formed such that the ends 41, 42 provide an initial breaking point about the continuous surface area 40 to focus the impact of bite force from an eater. (FIG. 3).

Like the zone of weakness 50 can be made weaker than the first and second regions 30, 35 adjacent thereto, the first and second regions 30, 35 can be made stronger than the continuous surface area 40 through shaping or thickening that would help capture or substantially eliminate random, unpredictable breaks.

The disclosures of all patents, patent applications (and any patents which issue thereon, as well as any corresponding published foreign patent applications), and publications mentioned throughout this patent application are hereby incorporated by reference herein. It is expressly not admitted, however, that any of the documents incorporated by reference herein teach or disclose the present invention. It is also expressly not admitted that any of the commercially available materials or products described herein teach or disclose the present invention.

What is claimed is:

1. A snack having a surface area, comprising:
a first side,
a second side opposed to the first side,
a first region wherein the first region is concave,
a second region opposed to the first region wherein the second region is concave, and
a continuous surface area positioned between the first region and the second region.

2. The snack of claim 1 wherein the continuous surface area further provides a signal of potential separation of the first region from the second region.

3. The snack of claim 1 wherein the continuous surface area further provides a signal of consistent breakage of the first region from the second region.

4. The snack of claim 1 wherein the continuous surface area further provides a signal of bite placement.

5. The snack of claim 1 wherein the first region and second region provide signals of minimal dip spillage.

6. The snack of claim 1 wherein the continuous surface area provides substantially predictable, consistent breakage between the first and the second regions via an application of force upon the continuous surface area.

7. The snack of claim 1 wherein the continuous surface area is substantially planar.

8. The snack of claim 1 wherein the continuous surface area provides a bending moment about which the first region and the second region arch upwardly away from a plane.

9. The snack of claim 1 wherein the continuous surface area is symmetric.

10. The snack of claim 1 wherein the first region possesses a concavity, the concavity encompassing a volume.

11. The snack of claim 10 wherein the concavity of the first region fully encompasses a volume.

12. The snack of claim 10 wherein the second region possesses a concavity, the concavity encompassing a volume.

13. The snack of claim 12 wherein the concavity of the second region fully encompasses a volume.

14. The snack of claim 1 wherein the first region is substantially a mirror image of the second region.

15. The snack of claim 1 wherein the snack comprises corn.

16. The snack of claim 1 wherein the snack comprises potato.

17. The snack of claim 1 wherein the snack comprises wheat.

18. The snack of claim 1 wherein the continuous surface area comprises at least one printed image.

19. The snack of claim 1 wherein the continuous surface comprises an embedded indication.

20. The snack of claim 1 wherein the characteristic width of the continuous surface area is smaller than the characteristic width of the first and second regions, and wherein the characteristic length of the continuous surface area is smaller than the characteristic length of the first and second regions.
